(19) United States
(12) Patent Application Publication
(10) Pub. No.: US 2020/0271680 A1
(43) Pub. Date: Aug. 27, 2020

(54) Specimen Processing System

(71) Applicant: Hitachi High-Technologies Corporation, Minato-ku, Tokyo (JP)

(72) Inventors: Tsuyoshi YAMAMOTO, Tokyo (JP); Kuniaki ONIZAWA, Tokyo (JP)

(21) Appl. No.: 16/646,023

(22) PCT Filed: Nov. 19, 2018
(86) PCT No.: PCT/JP2018/042664

§ 371 Date: Mar. 10, 2020

(30) Foreign Application Priority Data
Dec. 25, 2017 (JP) 2017-248433

(51) Int. Cl. G01N 35/04; G01N 35/00; G01N 35/02

(52) U.S. Cl. CPC G01N 35/04; G01N 35/026; G01N 35/00584

(57) ABSTRACT

A specimen processing system comprising a pre-processing device performing analysis pre-processing of a specimen contained in a specimen container, an analyzing device performing analysis processing of the specimen having been subjected to the pre-processing by the pre-processing device, a specimen transport unit transporting the specimen container between the pre-processing device and the analyzing device, and a transfer unit transferring the specimen between the analyzing device and the specimen transport unit, the specimen transport unit comprising a transport unit body, an extending line unit, a direction turning unit, and a terminal unit, and further provided with one control board that is mounted on the transport unit body or the transfer unit and controls operation of the transfer unit, the transport unit body, the extending line unit, the direction turning unit, and the terminal unit as transport control of the specimen container.

### TECHNICAL FIELD

The present invention relates to a specimen processing system that comprises an automatic analyzing device and a specimen processing device that are provided with transport lines that transfers a specimen container containing a specimen that is an analysis target.

### BACKGROUND ART

As an example of rack transport such that, even if congestion of racks occurs in an automatic analyzing device provided with a plurality of rack supplying ports connected to a specimen transport system, specimens that are not subjected to analysis indefinitely do not exist, Patent Literature 1 describes supplying alternately or supplying of the racks in the respective rack supply ports in a moderate distribution in a case where racks having been charged into low priority rack supply ports are expected not to be supplied for a long time until supply of racks having been charged into high priority rack supply ports is completed.

### CITATION LIST

### Patent Literature

Patent Literature 1: Japanese Patent Application Laid-Open No. 2014-130025

### SUMMARY OF INVENTION

### Technical Problem

In an automatic analyzing device performing quantitative/qualitative analysis of a specific component contained in a biological specimen such as blood and urine (hereinafter referred to as a specimen), and a specimen pre-processing device performing a pre-process such as a pre-process of a specimen to be required prior to analysis (the automatic analyzing device and the specimen preprocessing device will be hereinafter collectively referred to as a specimen processing system), the specimen is contained in an exclusive test tube (specimen container), and the test tube is mounted on a specimen container holder or the like and transferred in the respective devices and between the devices.

Regarding a transport path of the specimen, it is made capable of coping with various configurations according to the number and types of the automatic analyzing devices connected to the structure and system of a customer's facility itself.

In Patent Literature 1, a specimen processing system is disclosed which, in a case where specimens prior to analysis are set in a plurality of specimen supply sections, prevents the specimens prior to analysis from stagnating in the respective specimen supply sections by supplying the specimens alternately or in a moderate distribution to a specimen processing section.

However, in recent years, a problem has arisen in that the number of available IP addresses is restricted by an increase in the number of CPUs to be used according to diversification of the specimen processing system configuration and it is impossible to cope with various configurations which customers request.

Further, in the current specimen processing system, a specimen transport unit and a transfer unit are controlled in separate CPUs. Moreover, in the specimen transport unit, while the connection of an extending line unit is made possible, direction-turning is made impossible and, if the direction-turning is required, a specimen transport unit to be controlled with a different CPU is further required. Therefore, a problem has arisen in which device configuration is complicated and moreover an increase in an installation area of the system, and an increase in introduction cost and running cost occur.

The present invention has been made in view of the foregoing problems and has an object of providing a specimen processing system in which various system configuration can be constructed with control sections for control of transport lines that are less relative to the current specimen processing system.

### Solution to Problem

While the present invention has a plurality of means to solve the foregoing problems, for example, according to the present invention, there is provided a specimen processing system that comprises a pre-processing device performing analysis pre-processing of a specimen contained in a specimen container, an analyzing device performing analysis processing of the specimen having been subjected to the pre-processing by the pre-processing device, a specimen transport unit transporting the specimen container between the pre-processing device and the analyzing device, and a transfer unit transferring the specimen between the analyzing device and the specimen transport unit, the specimen processing system characterized in that the specimen transport unit comprises a transport unit body, an extending line unit, a direction turning unit, and a terminal unit and is provided with one control unit that is mounted on the transport unit body or the transfer unit and controls operation of the transfer unit, the transport unit body, the extending line unit, the direction turning unit, and the terminal unit as transport control of the specimen container.

### Advantageous Effects of Invention

According to the present invention, it is possible to construct various system configuration with control sections for control of transport line that are less relative to the current specimen processing system. Problems, configurations, and effects other than those described above will be made apparent from the following explanation of embodiments.

### BRIEF DESCRIPTION OF DRAWINGS

FIG. 1 is a schematic diagram of an example of an entire configuration of a specimen processing system according to an embodiment of the present invention.

FIG. 2 is an outline view that shows connection of a transport unit body, a transfer unit, an extending line unit, a direction turning unit, and a terminal unit in the specimen processing system according to the embodiment of the present invention.

FIG. 3 is a schematic diagram showing a configuration example of a range to be controlled by one CPU in the specimen processing system according to the embodiment of the present invention.

FIG. 4 is a schematic diagram showing a configuration example of a range to be controlled by one CPU in the specimen processing system according to the embodiment of the present invention.

FIG. 5 is a schematic diagram showing a configuration example of a range to be controlled by one CPU in the specimen processing system according to the embodiment of the present invention.

FIG. 6 is a schematic diagram showing a configuration example of a range to be controlled by one CPU in the specimen processing system according to the embodiment of the present invention.

FIG. 7 is a view showing a schematic configuration of a control board in the specimen processing system according to the embodiment of the present invention.

FIG. 8 is a flow chart showing connection contents of a range to be controlled by one CPU in the specimen processing system according to the embodiment of the present invention.

FIG. 9 is a flow chart showing a setting method of the control board in the specimen processing system according to the embodiment of the present invention.

### DESCRIPTION OF EMBODIMENTS

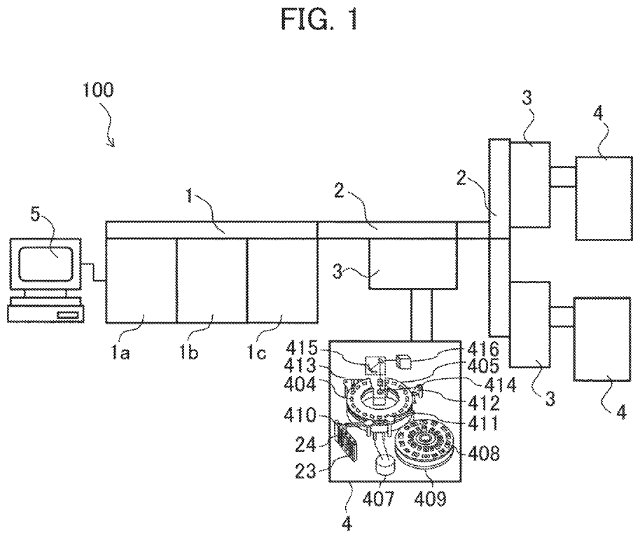

Referring to FIGS. 1 to 9, embodiments of a specimen processing system of the present invention will be explained.

Firstly, referring to FIG. 1, an entire configuration of the specimen processing system will be explained. FIG. 1 is a view showing the specimen processing system that processes a specimen such as blood and urine.

In FIG. 1, the specimen processing system 100 is provided with a pre-processing unit 1, specimen transport units 2, transfer units 3, analyzing devices 4, a control device 5, etc.

The pre-processing unit 1 is a unit performing analysis pre-processing of a specimen contained in a specimen container 24, and is composed of a specimen container holder charging section 1b, a specimen dispensing section 1c, a specimen container holder storing section 1a, etc.

The specimen container holder charging section 1b is a unit that feeds the specimen container 24 having a specimen such as blood or urine contained therein into a transport line and performs centrifugal separation of the specimen and unplugging of the specimen container 24. The specimen dispensing section 1c performs label-sticking with respect to the specimen container 24 for subdividing the specimen, dispensing of the specimen such as blood or urine, and the like. The specimen container holder storing section 1a is a unit that performs plugging, sorting, and storing of the specimen container 24 whose processing has been completed.

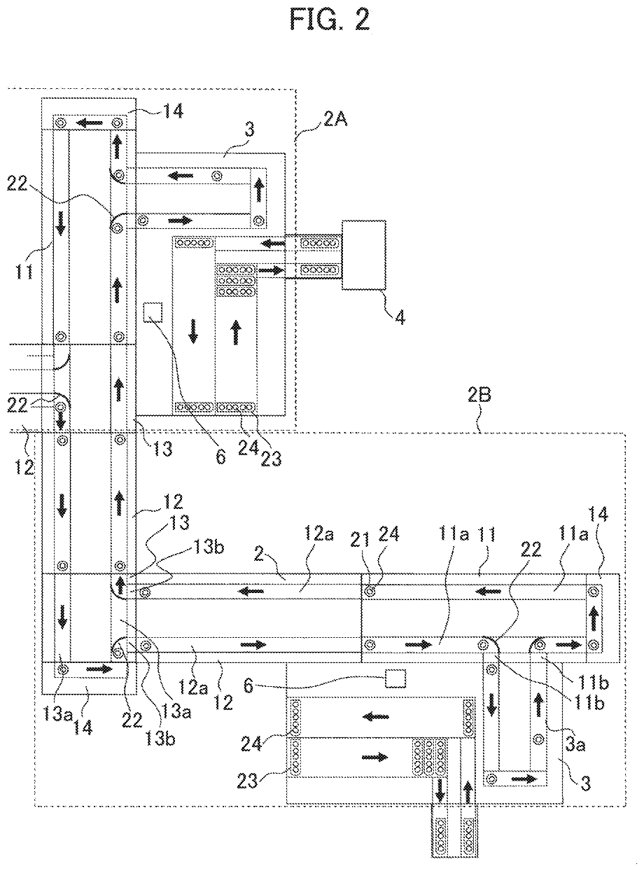

The specimen transport unit 2 is a unit that transfers a specimen container holder 21 (see FIG. 2) holding the specimen container 24 between the pre-processing unit 1 and the analyzing device 4 to a predetermined unit. Details thereof will be described hereinafter.

The transfer unit 3 is a unit that transfers the specimen container 24 held with respect to the specimen container holder 21 to a specimen rack 23 for charging the specimen container 24 into the analyzing device 4, in order to analyze the specimen container 24 with the analyzing device 4. Details thereof will be described hereinafter.

The analyzing device 4 is a section that measures the concentration of a biological component contained in the specimen having been subjected to the pre-processing by the pre-processing unit 1, and comprises a reaction container 404, a reaction disk mechanism 405, a thermostatic tank 407, a reagent chamber section 409, a specimen dispensing mechanism 410, a reagent dispensing mechanism 411, a stirring mechanism 412, a cleaning mechanism 413, a light source 414, a photometer 415, and an A/D (Analog/Digital) converter 416.

The reaction container 404 is a container in which a reagent and a specimen are put and that reacts the specimen with the reagent.

The reaction disk mechanism 405 is a member holding a plurality of reaction containers 404. Moreover, the reaction disk mechanism 405 transfers the reaction container 404 installed to itself to a designated position.

The thermostatic tank 407 is a mechanism for maintaining the reaction container 404 installed to the reaction disk mechanism 405 at a predetermined temperature and maintains the reaction container at the predetermined temperature.

The reagent chamber section 409 is a member that holds a plurality of reagent bottles that are containers storing reagents used in analysis. Moreover, the reagent chamber section 409 transfers the reagent bottles 408 installed to itself to a designated position.

The specimen dispensing mechanism 410 is provided with a specimen dispensing probe and is an instrument that divides the specimen by a given small amount each. The specimen dispensing mechanism 410 dispenses a predetermined amount of the specimen contained in the specimen container 24 into the reaction container 404.

The reagent dispensing mechanism 411 is provided with a reagent dispensing probe and is an instrument that divides the reagent by a given small amount each. The reagent dispensing mechanism 411 dispenses a predetermined amount of the reagent contained in the reagent bottle 408 into the reaction container 404.

The stirring mechanism 412 is an instrument that stirs the solution of the specimen and reagent contained in the reaction container 404 to uniformize a distribution state of the components.

The cleaning mechanism 413 is an instrument that performs aspiration of waste liquid and discharging of cleaning liquid. The cleaning mechanism 413 aspirates the solution of the reagent and specimen contained in the reaction container 404. Moreover, the cleaning mechanism 413 ejects the cleaning liquid into the reaction container 404 to clean the reaction container 404.

The light source 414 is a section emitting light used for spectrometry and is composed of a halogen lamp, an LED, etc.

The photometer 415 is a section that receives the light, emitted by the light source 414 and passing through the reaction container 404, to measure the absorbance of the solution in the reaction container 404, and is composed of a spectrophotometer or the like. The photometer 415 transmits information of the absorbance to the A/D converter 416.

The A/D converter 416 is an implement converting an analog signal into a digital signal and converts conducts the inputted analog signal into the digital signal and thereafter performs recording of it in a database.

Incidentally, while the device that performs biochemical analysis of blood or the like as the analyzing device 4 is explained as an example in FIG. 1, the analyzing device is not limited to the biochemical analyzing device and may be an immunological analyzing device or the like that performs immunological analysis.

The control device 5 is connected to all of the pre-processing unit 1, the specimen transport unit 2, the transfer unit 3 and the analyzing device 4 on a network such as LAN and can perform the overall control of the respective instruments in these respective units and various processes including arithmetic operation of analysis results or the like.

In the specimen processing system 100 described above, it is necessary to modify the number of and arrangement of the specimen transport units 2 and the transfer units 3 according to system configuration required for every customer.

Next, referring to FIG. 2 to FIG. 9, details of configuration of the specimen transport unit 2 and the transfer unit 3 and connecting method of the units will be explained.

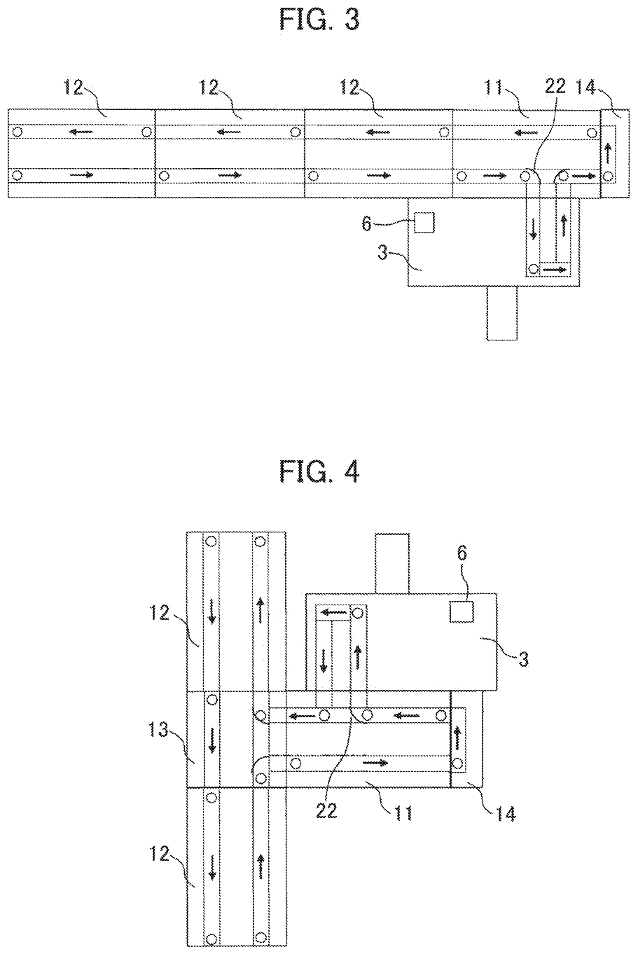

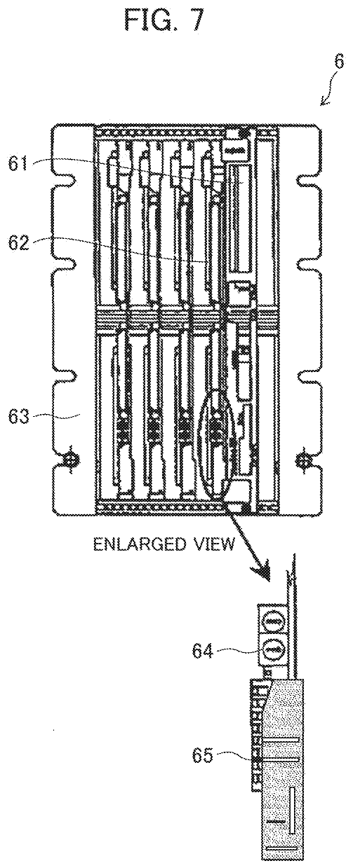

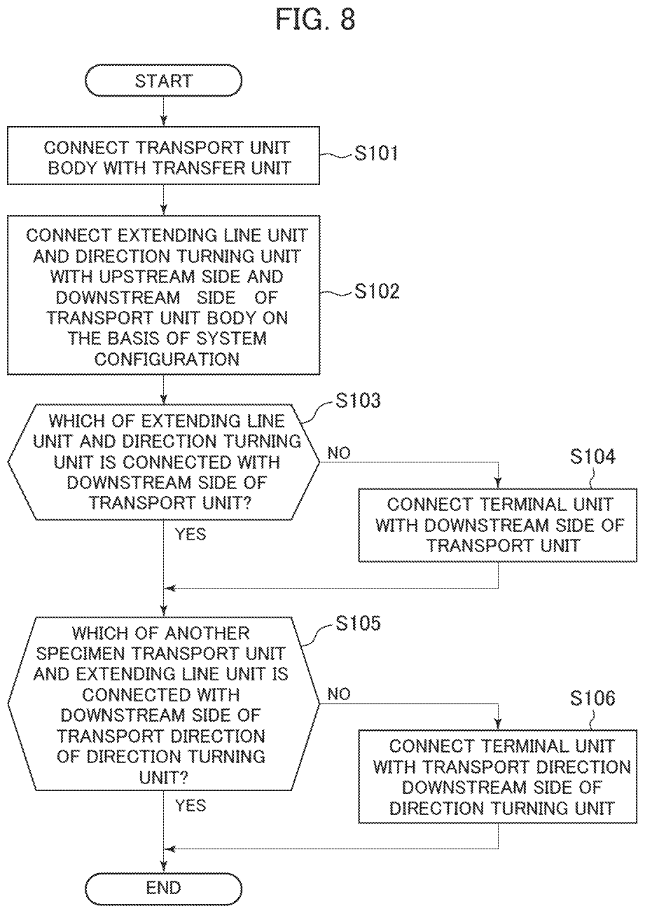

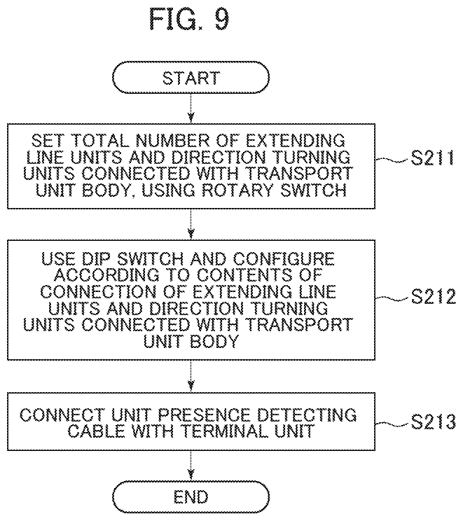

In FIG. 2, an example of the connection of the specimen transport unit 2 and the transfer unit 3 in the present invention is illustrated. In FIG. 3 to FIG. 6, examples of the configuration of the specimen transport unit 2 and the transfer unit 3 which are made controllable with one CPU substrate 61 are shown. In FIG. 7, a schematic configuration of a control board 6 having one CPU substrate 61 is shown. In FIG. 8, a flow chart of a connection method of the specimen transport unit 2 and the transfer unit 3 made controllable with one CPU substrate 61 in the present invention is shown. In FIG. 9, a flow chart of a setting method of the control board made controllable with one CPU substrate 61 in the present invention is shown. Incidentally, reference signs that are identical to those in FIG. 1 denote identical parts.

As shown in FIG. 2, the specimen transport unit 2 is configurated by connecting the required number of extending lines 12, direction turning units 13, and terminal units 14 that are required according to the system configuration, with respect to a transport unit body 11.

For example, as shown in FIG. 2, a specimen transport unit 2 can be employed that comprises a specimen transport unit 2A composed of one transport unit body 11, one extending line unit 12, one direction turning unit 13, and one terminal unit 14, and a specimen transport unit 2B composed of one transport unit body 11, two extending line units 12, one direction turning unit 13, and one terminal unit 14.

Each of these specimen transport unit 2A and specimen transport unit 2B becomes a cover range for one CPU substrate 61 (see FIG. 7) provided at the control board 6.

Incidentally, the configuration of the specimen transport unit 2 in which the specimen transport unit 2 is covered with the one CPU substrate 61 is not limited to such forms of the specimen transport unit 2A and the specimen transport unit 2B as shown in FIG. 2 and, as shown in FIG. 3 to FIG. 6, various arrangement configurations can be employed within a range satisfying the above-mentioned maximum requirements.

For example, as shown in FIG. 3, a configuration may be employed in which three extending line units 12 are arranged at one side of the transport unit body 11 and one terminal unit 14 is arranged at the other side of the transport unit body 11.

Alternatively, as shown in FIG. 4, a configuration may be employed in which a direction turning unit 13 is arranged at one side of the transport unit body 11, a terminal unit 14 is arranged at the other side of the transport unit body 11, and extending line units 12 are respectively arranged one by one at the direction turning unit 13.

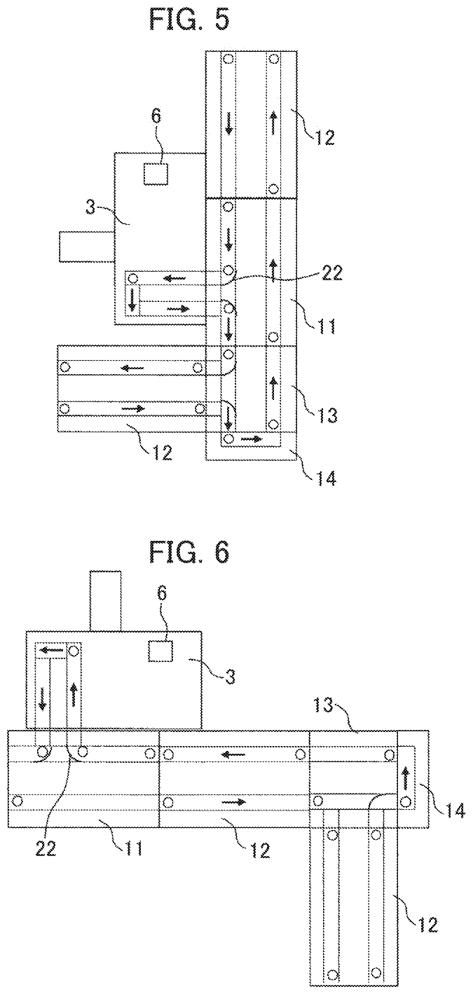

Also, as shown in FIG. 5, a configuration may be employed in which one direction turning unit 13 is arranged at one side of the transport unit body 11, one extending line unit 12 is arranged at the other side of the transport unit body 11, and an extending line unit 12 and a terminal unit 14 are respectively arranged one by one at the direction turning unit 13.

Moreover, as shown in FIG. 6, a configuration may be employed in which an extending line unit 12, a direction turning unit 13, an extending line unit 12, and a terminal unit 14 are arranged at one side of the transport unit body 11.

In the forms shown in FIG. 3 to FIG. 6, any of a transport unit body 11, an extending line unit 12, and a direction turning unit 13 of another specimen transport line unit 2 is arranged outside the range covered with one CPU substrate 61.

Thus, the range of the specimen transport unit 2 covered with one CPU substrate 61 is, at most, one transport unit body 11, three or less extension line units 12 and direction turning units 13 in total, and terminal units 14 as many as the direction turning units 13, and the required number of extending line units 12, direction turning units 13 and terminal units 14 are connected according to the system configuration.

By this configuration, to connect the extending line unit 12 and the direction turning unit 13 in the transport unit body 11 is made possible and an unordered connection is made possible. And, to construct manifold system configurations in one CPU substrate 61 control is made possible.

Returning to FIG. 2, the transport unit body 11 comprises two transport lines 11a transferring the specimen container 24 in one direction, two branch lines direction-turning the specimen container 24 from the transport lines 11a, and a branch lever 22 disposed at a connection part between the branch lines 11b and the transport lines 11a.

In the transport unit body 11, the transfer unit 3 is connected directly in either of vertical directions with respect to the transport direction. In the present invention, connection in the both directions is not accepted in order to reduce the number of mounted CPU substrates 61 of the control board 6. In the transport unit body 11, a flow direction of the specimen container holder 21 is changed by falling down the branch lever 22, the specimen container holder 21 is transferred into the transfer unit 3 or the specimen container holder 21 is discharged into the transfer unit 3.

In the transport unit body 11, it is possible to connect the extending line unit 12 and the direction turning unit 13 in either the front and rear of a horizontal direction with respect to the transport direction of the specimen container 24, and the connection order is a random order as shown in FIG. 2 and FIGS. 3 to 6.

Further, when there is no connection of the extending line unit 12 and the direction turning unit 13 both in the front and rear of the horizontal direction with respect to the transport direction of the transport unit body 11, the terminal unit 14 is connected.

The extending line unit 12 is a unit connecting two points separated in a straight direction and it is possible to connect the transport unit body 11, the extending line unit 12, and the direction turning unit 13 in the front and rear sides. The extending line unit 12 is provided with two transport lines 12a transferring the specimen container 24 in one direction.

The direction turning unit 13 is a unit changing the transport direction of the specimen container 24, includes two transport lines 13a transferring the specimen container 24 in one direction, two branch lines 13b direction-turning the specimen container 24 from the transport lines 13a, and a branch lever 22 disposed in a connection portion between the transport branch lines 13b and the transport lines 13a, and makes it possible to direction-turn the transport direction of the specimen container holder 21.

In the direction turning unit 13, it is possible to connect the transport unit body 11, the extending line unit 12, and the terminal unit 14 even in any of four directions including the horizontal and vertical directions with respect to the transport direction of the specimen container 24. When the transport unit body 11 and the extending line unit 12 are connected in the vertical direction with respect to the transport direction of the direction turning unit 13, the flow direction of the specimen container holder 21 is changed by falling down the branch lever 22 and the specimen container holder 21 is transferred into the connected transport unit body 11 and extending line unit 12. If there is no connection between the transport unit body 11 and the extending line unit 12 in the horizontal direction with respect to the transport direction of the direction turning unit 13, the terminal unit 14 is connected.

The terminal unit 14 is a unit disposed at the end portion of the specimen transport unit 2. The presence of this terminal unit 14 allows the units to be connected to the downstream side by a transport path of single stroke writing (one-way transport). That is, when there is no connection of the units to the downstream side with respect to the transport unit body 11 and the direction turning unit 13, the terminal unit 14 allows the transport path not to be interrupted.

As shown in FIG. 2, the transfer unit 3 includes a U-shaped transport line 3a connected to the branch line 11b of the transport unit body 11. As shown in FIG. 3 and FIGS. 3 to 6, on the transfer unit 3, the control board 6 is mounted. The transfer unit 3 is required to be connected directly to the transport unit body 11 in order to control the specimen transport unit 2.

In the transfer unit 3, the specimen container 24 held with respect to the specimen container holder 21 is transferred into the specimen rack 23 and transferred to the analyzing device 4. Further, the specimen container 24 whose analyzing process is completed in the analyzing device 4 is transferred from the specimen rack 23 to the specimen container holder 21 and transferred to the specimen transport unit 2.

As shown in FIG. 7, the control board 6 includes a CPU substrate 61, a motor controller substrate 62, a VME rack 63, a rotary switch 64, and a dip switch 65.

The CPU substrate 61 directly controls the operation of the transfer unit 3, the transport unit body 11, the extending line unit 12, the direction turning unit 13, and the terminal unit 14, based on a control signal from the control device 5.

The motor controller substrate 62 generates and outputs drive signals for the respective units in the specimen transport unit 2, and a motor or the like provided in the transfer unit 3, based on the control signal from the CPU substrate 61.

The VME rack 63 is a rack holding the CPU substrate 61, the motor controller substrate 62, the rotary switch 64, and the dip switch 65.

The rotary switch 64 is a switch setting the number of connections of the extending line unit 12 and the direction turning unit 13 in the specimen transport unit 2.

The dip switch 65 is a switch setting the connection direction of the extending line unit 12, the direction turning unit 13, and terminal unit 14 in the specimen transport unit 2.

Next, referring to FIG. 8, a method of connecting the transfer unit 3 and the specimen transport unit 2 for enabling control in one CPU substrate 61 of the specimen processing system in the present invention will be explained.

In FIG. 8, the transport unit body 11 and the specimen transport unit 2 are firstly connected in order to make it possible to control the transfer unit 3 and the specimen transport unit 2 with one CPU substrate 61 (Step S101).

Next, based on the system configuration, the extending line units 12 and the direction turning units 13 of the required number connected to the transport unit body 11 are connected (Step S102). At this time, the direction for connection of the extending line unit 12 and the direction turning unit 13 with respect to the transport unit body 11 is unordered.

Next, whether or not the extending line unit 12 and the direction turning unit 13 are connected to the downstream side of the transport unit body 11 of interest in the required system configuration is confirmed (Step S103). When either the extending line unit 12 or the direction turning unit 13 is connected to the downstream side of the transport unit body 11, process progresses to Step S105 and, when both are not connected, the process progresses to Step S104.

If the extending line unit 12 and the direction turning unit 13 are not connected to the downstream side of the transport unit body 11 of interest in the required system configuration, the terminal unit 14 is connected to the downstream side of the transport unit body 11 of interest in the required system configuration (Step S104).

Next, whether or not the transport unit body 11 and the extending line unit 12 are connected to the downstream side of the transport direction of the direction turning unit 13 of interest in the required system configuration is confirmed (Step S105). When either the extending line unit 12 or the direction turning unit 13 is connected to the downstream side of the transport direction of the direction turning unit 13, the process is finished and, when both are not connected, the process progresses to Step S106.

If the transport unit body 11 and the extending line unit 12 are not connected to the downstream side of the direction turning unit 13 of interest in the required system configuration, the terminal unit 14 is connected to the transport direction downstream side of the direction turning unit 13 (Step S106) and the process is ended.

Next, referring to FIG. 9, a setting method of the rotary switch 64 and the dip switch 65 will be explained which is performed in order to recognize the respective units in a combination of the extending line unit 12, the direction turning unit 13, and the terminal unit 14 connected to the transport unit body 11 of the specimen transport unit 2 in the specimen processing system according to the embodiment 1 of the present invention.

As shown in FIG. 9, based on the configuration of the specimen transport unit 2 which enables the control in one CPU substrate 61, the total number of the extending line units 12 and the direction turning units 13 connected directly or indirectly with the transport unit body 11 is set by the rotary switch 64 (Step S211). In this Step S211, the extending line unit 12 and the direction turning unit 13 are not distinguished and the total number of the extending line units 12 and the direction turning units 13 is set.

Then, in accordance with the connection contents of the extending line unit 12 and the direction turning unit 13 connected to the transport unit body 11, configuration is performed on the basis of determined criteria, using the dip switch 65 (Step S212). For example, in the case of such a configuration of the specimen transport unit 2A as shown in FIG. 2, a pattern A is configured, in the case of such a configuration of the specimen transport unit 2B, a pattern B is configured, in the case of such arrangement as shown in FIG. 3, a pattern C is configured, in the case of such arrangement as shown in FIG. 4, a pattern D is configured, in the case of such arrangement as shown in FIG. 5, a pattern E is configured, in the case of such arrangement as shown in FIG. 6, a pattern F is configured.

Then, if the terminal unit is connected to the transport unit body 11 and the direction turning unit 13, a unit presence detecting cable for the terminal unit 14 is connected to the terminal unit 14 (Step S213). Thereby, the CPU substrate 61 of the control board 6 is made capable of discriminating the presence and absence of the terminal unit 14.

By the control board 6 set in this way, the specimen transport operation by the specimen transport unit 2 and the transfer unit 3 is controlled.

Next, the effects of the present embodiment will be explained.

The specimen processing system 100 of the present embodiment described above is provided with the pre-processing unit 1 performing analysis pre-processing of the specimen stored in the specimen container 24, the analyzing device 4 performing analysis processing of the specimen subjected to the pre-processing by the pre-processing unit 1, the specimen transport unit 2 transporting the specimen container 24 between the pre-processing unit 1 and the analyzing device 4, and the transfer unit 3 transferring the specimen between the analyzing device 4 and the specimen transport unit 2, and the specimen transport unit 2 includes the transport unit body 11, the extending line unit 12, the direction turning unit 13, and the terminal unit 14, and is further provided with one control board 6 which is mounted on the transport unit body 11 or the transfer unit 3 and controls the operation of the transfer unit 3, the transport unit body 11, the extending line unit 12, the direction turning unit 13, and the terminal unit 14 as a transport control of the specimen container 24.

In this way, the specimen transport unit 2 is unit-configurated in such a manner to be appropriately configuration-changeable in accordance with the configuration of the specimen processing system 100, and also the transfer unit 3 and the specimen transport unit 2 are controlled by one control board 6, to thereby enable the control of various system configurations in the same CPU substrate 61. Therefore, it is possible to reduce the number of uses of the CPU substrate 61 in the entire specimen processing system 100, and it is possible to reduce the number of IP addresses required and to realize the diversification of the entire configuration of the specimen processing system 100.

Also, the extending line unit 12 and the direction turning unit 13 are connected with respect to the transport unit body 11 in no particular order, so that it is possible to construct various system configurations more easily.

Further, the transfer unit 3 and the transport unit body 11 are directly connected, so that it is possible to easily realize control circuit configuration in the same CPU substrate 61.

Moreover, the control board 6 comprises the rotary switch 64 and the dip switch 65 that are configured based upon the connection contents of the extending line unit 12 and the direction turning unit 13 in the specimen transport unit 2, so that the control circuit configuration by one CPU substrate 61 can be more easily realized.

Further, at the end portion of the specimen transport unit 2, the terminal unit 14 is disposed, and the transfer unit 3, the transport unit body 11, the extending line unit 12, the direction turning unit 13, and the terminal unit 14 transport the specimen container 24 in one way, whereby it is possible to form a transport path of single stroke writing and to secure a wide control range by one CPU substrate 61. Therefore, it is possible more effectively reduce the total number of the CPU substrates 61 used in the entire system.

Also, the transport unit body 11 includes the two transport lines 11a transferring the specimen container 24 in one direction, the two branch lines 11b for direction-turning the specimen container 24 from the transport lines 11a, and the branch lever 22 disposed at the connection portion between the branch lines 11b and the transport lines 11a, and the direction turning unit 13 includes the two transport lines 13a transferring the specimen container 24 in one direction, the two branch lines 13b for direction-turning the specimen container 24 from the transport lines 13a, and the branch lever 22 is disposed at the connection portion between the branch lines 13b and the transport lines 13a, whereby it is possible to more easily form the transport path of single stroke writing.

Furthermore, the transfer unit 3 includes the U-shaped transport line 3a connected to the branch line 11b of the transport unit body 11, whereby it is also possible to more easily form the transport path of single stroke writing.

Furthermore, the extending line unit 12 is provided with two transport lines transferring the specimen container 24 in one direction, thereby making it possible to more easily form the transport path of single stroke writing.

Moreover, the specimen transport unit 2 is composed of one transport unit body 11, three or less extending line unit 12 and direction turning unit 13 in total, and the terminal units 14 as many as the direction turning units 13, thereby making it possible to ensure a maximum control target range by one control board 6 and to more effectively reduce the total number of the CPU substrates to be used in the entire system.

Further, the control board 6 is mounted on the transfer unit 3, whereby there is room in the space, so that it is possible to easily incorporate various substrates including the CPU substrate 61 in the control board 6 and to widely secure the control target range by one control board 6.

### (Others)

Incidentally, the present invention is not limited to the above-mentioned embodiments and various modifications and applications can be made. The above-mentioned embodiments are those described in detail in order to explain the present invention in an easily understandable manner and are not necessarily limited to those comprising all the configurations described.

For example, while the case where the control board 6 is mounted on the transfer unit 3 has been explained in the above-mentioned embodiments, the unit on which the control board 6 is mounted is not limited to the transfer unit 3 and the control board 6 may be mounted on the transport unit body 11. Even in this case, the method of connection between the transfer unit 3 and the transport unit body 11 and the connection method of the transport unit body 11, the extending line unit 12, the direction turning unit 13, and the terminal unit 14 are the same as in the above-mentioned embodiments.

### REFERENCE SIGNS LIST

1: Pre-processing unit (Pre-processing device)
1a: Specimen container holder storing section
1b: Specimen container holder charging section
1c: Specimen dispensing section
2, 2A, 2B: Specimen transport unit
3: Transfer unit
3a: Transport line
4: Analyzing device
5: Control device
6: Control board (Control unit)
11: Transport unit body
11a: Transport line
11b: Branch line
12: Extending line unit
12a: Transport line
13: Direction turning unit
13a: Transport line
13b: Branch line
14: Terminal unit
21: Specimen container holder
22: Branch lever
23: Specimen rack
24: Specimen container
61: CPU substrate
62: Motor controller substrate
63: VME rack
64: Rotary switch
65: Dip Switch
100: Specimen processing system
404: Reaction container
405: Reaction disk mechanism
407: Thermostatic tank
408: Reagent bottle
409: Reagent chamber section
410: Specimen dispensing mechanism
411: Reagent dispensing mechanism
412: Stirring mechanism
413: Cleaning mechanism
414: Light source
415: Photometer
416: A/D converter

1. A specimen processing system comprising: a pre-processing device performing analysis pre-processing of a specimen contained in a specimen container;
an analyzing device performing analysis processing of the specimen having been subjected to the pre-processing by the pre-processing device;
a specimen transport unit transporting the specimen container between the pre-processing device and the analyzing device; and
a transfer unit transferring the specimen between the analyzing device and the specimen transport unit; the specimen processing system characterized in that the specimen transport unit comprises a transport unit body, an extending line unit, a direction turning unit, and a terminal unit and is provided with one control unit that is mounted on the transport unit body or the transfer unit and controls operation of the transfer unit, the transport unit body, the extending line unit, the direction turning unit, and the terminal unit as transport control of the specimen container.

2. The specimen processing system according to claim 1, characterized in that the extending line and the direction turning unit are connected to with respect to the transport unit body in no particular order.

3. The specimen processing system according to claim 2, characterized in that the transfer unit and the transport line body are connected directly.

4. The specimen processing system according to claim 2, characterized in that the control unit comprises a rotary switch and a dip switch that are set based upon connection contents of the extending line unit and the direction turning unit in the specimen transport unit.

5. The specimen processing system according to claim 2, characterized in that the specimen transport unit has the terminal unit arranged at an end portion thereof, and the transfer unit, the transport line body, the extending line unit, the direction turning unit, and the terminal unit transport the specimen container in one way.

6. The specimen processing system according to claim 5, characterized in that the transport line body and the direction turning unit comprises two transport lines transferring the specimen container in one direction, two branch lines direction-turning the specimen container from transport line, and a branch lever disposed at a connection portion between the branch lines and the transport lines.

7. The specimen processing system according to claim 6, characterized in that the transfer unit comprises a U-shaped transport line connected to the branch lines of the transport line body.

8. The specimen processing system according to claim 5, characterized in that the extending line unit is provided with two transport lines transferring the specimen container in one direction.

9. The specimen processing system according to claim 1, characterized in that the specimen transport unit is composed of one transport unit body, three or less extending line units and direction turning units in total, and terminal units as many as the direction turning units.

10. The specimen processing system according to claim 3, characterized in that the control unit is mounted on the transfer unit.
